(19) United States
(12) Patent Application Publication
(10) Pub. No.: US 2005/0185665 A1
(43) Pub. Date: Aug. 25, 2005

(54) Management method for a bidirectional and simultaneous exchange of digital signals and a corresponding interface for a bidirectional and simultaneous communication

(76) Inventor: Andrea Uboldi, Fenegro (IT)

Correspondence Address: SEED INTELLECTUAL PROPERTY LAW GROUP PLLC, 701 FIFTH AVENUE, SUITE 6300, SEATTLE, WA, 98104-7092, US

(21) Appl. No.: 11/039,379

(22) Filed: Jan. 18, 2005

Related U.S. Application Data
(63) Continuation-in-part of application No. PCT/EP03/07760, filed on Jul. 17, 2003.

(30) Foreign Application Priority Data
Jul. 18, 2002 (IT) MI2002A 001582

(51) Int. Cl. H04L 12/43

(52) U.S. Cl. 370/458

(57) ABSTRACT

A management method is described for a bidirectional and simultaneous exchange of digital signals between at least a first device and a second device, both provided with a corresponding interface and interconnected by a connecting wire where there is a pure digital signal that can take only two voltage levels. The method includes: sensing a voltage level of the connecting wire; sensing a current supplied to the connecting wire by the interface of the first device, without changing the voltage level of the connecting wire; local reconstruction of a logical level transmitted by the interface of the second device by a logical recombination of the voltage level sensed on the connecting wire and the logical level transmitted by the interface of the first device, depending on the current supplied by the interface of the first device to the connecting wire.

### BACKGROUND OF THE INVENTION

1. Field of the Invention

The present invention relates to a method for managing a bidirectional and simultaneous exchange of digital signals and to a corresponding interface for a bidirectional and simultaneous communication of digital signals suitable to implement such a method.

Specifically, this invention relates to an electronic system for the transmission of digital signals over a single conductive means in a bidirectional and simultaneous way, the system comprising a plurality of N devices (where N is a number greater than 1) such as digital electronic circuits, which can communicate to each other and are interconnected by means of a single wire. The application field of such a configuration extends to all those digital systems which need a bidirectional connection (serial or parallel) among several devices or among several parts of a device (e.g. microprocessors and peripheral ICs) that should communicate.

2. Description of the Related Art

It is well known that the constant growth of digital devices in every application field of electronics has made it necessary the development of communication standards in order to guarantee that different kinds of digital devices can be interfaced into a communication system. Thanks to their ease of use and implementation, today the most used communication systems in this field are the serial ones. In fact, they ensure a good data exchange with a minimum number of connections among the elements of the system.

Such digital communication systems are generally used for communications among the devices on a single circuit board. Therefore, they do not need to cover long distances but generally a few centimeters of wire are enough to ensure a correct electrical connection among all the devices that have to communicate.

The known digital communication systems have different kinds of serial connection:
a. unidirectional serial communication, where the exchange of digital signals takes place in one single direction: the devices communicating this way behave either as transmitter or as receiver;
b. bidirectional serial communication, where the exchange of digital signals takes place in two directions: the devices communicating this way behave at the same time both as receiver and as transmitter. In fact, they are interconnected through two separated wires for the exchange of the digital signals in the two directions;
c. serial bidirectional communication on a single wire (in the simplest bus configuration), where the exchange of digital signals takes place in two directions: the devices communicating this way behave both as transmitter and as receiver but never at the same time since the transmission means is the same for both the directions of the communication.

In particular as far as it regards the modalities of the bidirectional communication in the field of the invention, it should be noted that several digital integrated circuits (such as microprocessors) are provided with serial interfaces, such as for example the USART interface (acronym of Universal Synchronous Asynchronous Receiver Transmitter). They allow a full-duplex exchange of digital signals between two devices, using two separated wires for the two directions of the simultaneous communication, as it is schematically shown in FIG. 1.

In particular, FIG. 1 schematically shows a system 1 for the digital bidirectional communication including a first electronic device D1 and a second electronic device D2, inserted between a first voltage reference and a second voltage reference, in particular a power supply voltage Vcc and a ground GND.

The electronic devices D1 and D2 are both provided respectively with a first interface TX1, TX2 and a second interface RX1, RX2, for example of USART type, and they are connected to one another by a first wire C1 and a second wire C2 between the corresponding interfaces.

Even though it is still very used (many traded microprocessors are provided with a USART interface), this system does not allow implementing a communication among more than two devices, where every device can communicate with another connected device. In fact, since there are two separated wires for the transmission of the data in the two directions, it is not convenient to adopt a bus configuration.

In practice, the frequent need of connecting several peripheral integrated circuits of a digital system with one or more control units (e.g. microprocessors) and of having a more flexible configuration has made it necessary the development of bus architectures for the communication. On the bus takes place the exchange of digital signals in the two directions at different times between two arbitrary devices of the system that must communicate at a given moment.

This way it is ensured the transmission of digital signals among a big number of devices connected by means of a single wire. It is also known to use an additional wire for a synchronization signal.

One of the most known serial communication buses is the so-called I²C bus, described in the U.S. Pat. No. 4,689,740 in the name of Philips Corporation, which is used for the communication among integrated circuits.

A bus system according to the I²C bus standard is schematically shown in FIG. 2 and generally indicated as 2. In particular the I²C bus system 2 comprises a bus BUS2, provided with a first wire SDA (serial data line) for the data transmission and with a second wire SCL (serial clock line) for the synchronization signal transmission to a plurality of devices D3, D4, D5, D6 included into the system 2.

Every wire SDA, SCL is held to a first logical level through a corresponding external pull-up resistor (R1, R2), which allows to implement a logical AND operation on the bus BUS2 using open-collector/open-drain drivers for the communication.

Connecting several devices together into a bus system using a single wire for the exchange of bidirectional digital signals has some advantages, linked to the circuital simplicity and to the flexibility of the communication system that is obtained this way. Although, it has some disadvantages too. In particular, the amount of the exchanged data is unavoidably reduced compared to the one of communication systems whose transmission and receiving wires are separated.

In fact, in a single-wire bus system the communication cannot take place in two directions at the same time. Besides a device-addressing byte that is transmitted at the beginning of the communication, also some start and stop bits are present in the transmitted data packets. A so-called MASTER device should transmit some proper control bits for the direction of the communication.

For example, to control a talk session between a microcontroller (MASTER) and an EEPROM memory (SLAVE), after the microcontroller has transmitted to the memory the address of the location that it wants to read, the direction of the communication must change since the memory has to transmit the data contained in that location and the microcontroller has to receive it.

The possibility of a data conflict when two devices try to transmit at the same time is avoided using restrictive communication protocols, which should be respected by every device connected to the bus.

In FIG. 3 are shown the interfaces used in the I²C bus system of FIG. 2.

The interface of the I²C bus system has a relatively simple hardware structure. It needs in particular a buffer 3 for receiving serial data, a buffer 4 for receiving the synchronization signal, an open-collector/open-drain driver 5 for the transmission of serial data and another driver 6 for the transmission of the synchronism signal.

The I²C bus system 2 is controlled by a communication protocol defined by the communication standard I²C, which controls the functioning and coordinates the transmission, receiving and addressing operations among the connected devices avoiding data conflicts.

A bidirectional simultaneous communication system over one wire is described in the U.S. Pat. No. 5,436,887 to Eisenhut (Storage Technology Corp.). This document aims to provide a full-duplex communication between two devices that provides a relative immunity to noise compared to the known three-level communications. According to this document a conventional open-collector scheme plus a current detection device is used. The current detection is achieved by a resistor placed in series on the branch of the driver or on the branch of the bus. Moreover, the voltage of the bus and the current detection are used to reconstruct the signal transmitted by the opposite device. Since the current-sensing device (resistor) is sensible to small variations of the bus voltage, this kind of interface has very small noise margin.

### BRIEF SUMMARY OF THE INVENTION

Embodiments of the invention provide a bidirectional digital communication system with structural and functional features that overcome the complexity linked to the hardware structures and to the protocols that still limit the systems made according to the prior art.

One of the concepts behind embodiments of the present invention is to allow a plurality of devices connected to at least one wire to transmit and to receive simultaneously a digital signal by means of a combined voltage and current sensing on said wire. The method also provides a proper logical combination between the logical level of the wire and the level that is being transmitted onto the wire itself, thus distinguishing the two signals transmitted by the two devices.

The features and advantages of the management method, of the communication system, and of the related interface according to the invention will be apparent from the following description of an embodiment thereof given by way of non-limiting example with reference to the attached drawings.

### BRIEF DESCRIPTION OF DRAWINGS

In the drawings:

FIG. 1 is a schematic view of a first embodiment of a system for a bidirectional digital communication according to the prior art;

FIG. 2 is a schematic view of a second embodiment of a system for a bidirectional digital communication according to the prior art;

FIG. 3 is a view of with more detail the interface of the embodiment of FIG. 2;

FIG. 4A is a schematic view of a system for a bidirectional and simultaneous communication according to an embodiment of the invention;

FIG. 4B is a view of a general form of the system of FIG. 4A in order to illustrate the method to manage the exchange of digital signals according to an embodiment of the invention;

FIG. 5 is a schematic view of the connection between a plurality of devices using the system of FIG. 4A;

FIG. 6 is a more detailed view of a block diagram of interface for a bidirectional and simultaneous communication according to an embodiment of the invention;

FIG. 7 is a schematic view of a possible pattern of a plurality of signals inside the interface of FIG. 6;

FIG. 8 is a more detailed view of a transmission block of the interface of FIG. 6; and

FIG. 9 is a more detailed view of a receiving block of the interface of FIG. 6.

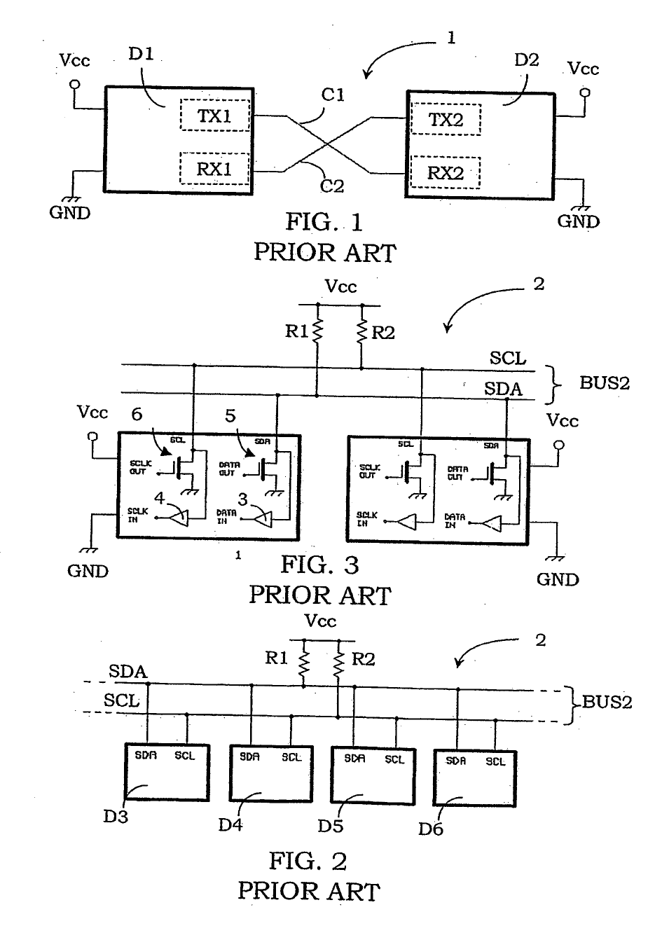

### DETAILED DESCRIPTION

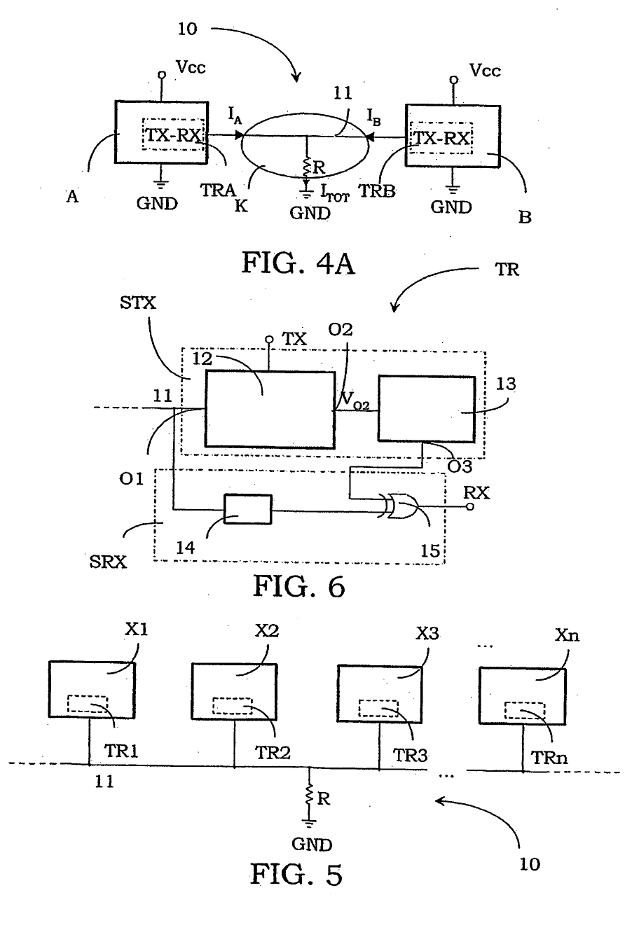

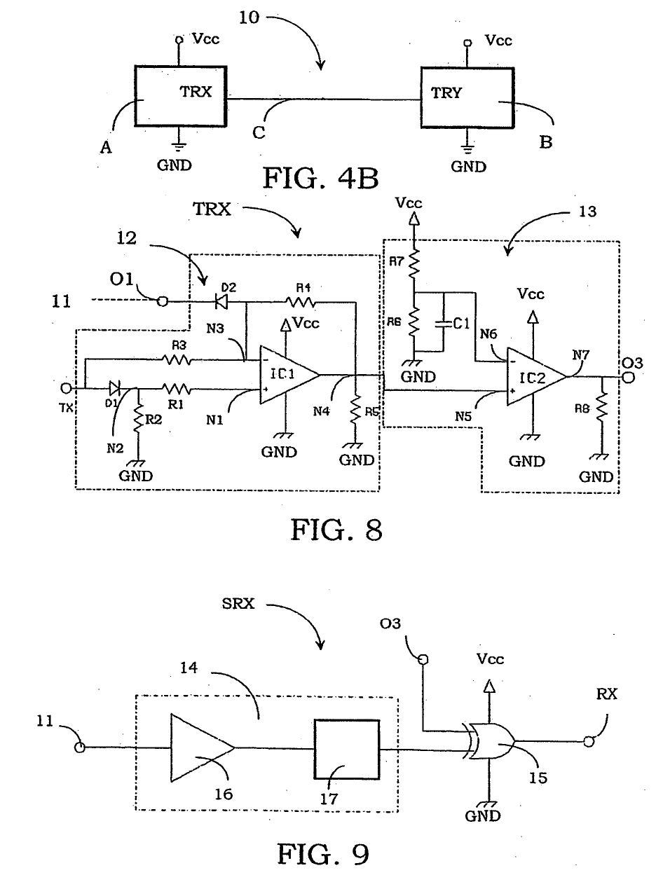

Referring to these figures, and particularly to FIG. 4A, it is schematically indicated with 10 a system for a bidirectional and simultaneous digital communication implemented according to an embodiment of the invention.

As will be clear from the detailed description that follows, the proposed transmission method does not use multilevel signals, modulation signals or signals obtained by summing the received and transmitted signals. The particularity of this system is that the signal of the wire is an ALL-OR-NOTHING digital signal, which has only two voltage levels (corresponding to the logical levels 1 and 0). This signal is quite similar to the signal of a wire in the case of a bidirectional digital communication according to the prior art.

In a simplified embodiment, the system 10 for a bidirectional and simultaneous communication comprises at least a first device A and a second device B, in particular integrated digital circuits, inserted between a first voltage reference and a second voltage reference, more in particular a power supply voltage Vcc and a ground GND, and connected to one another by means of a wire 11.

Advantageously according to an embodiment of the invention, the bidirectional and simultaneous communication system 10 further comprises a resistive element R (which acts as pull-down or pull-up resistor) between the wire 11 and a voltage reference, for example the ground GND. Even though in the rest of the document reference will be only made to a system with the wire 11 connected to the ground GND by a resistive element R, it is also possible to build a system comprising a resistor R connected to any other voltage reference, such as for example the power-supply voltage reference Vcc.

The first device A and the second device B of the bidirectional and simultaneous communication system 10 further comprise corresponding interfaces TRA, TRB connected together by the wire 11.

Advantageously according to an embodiment of the invention, the interfaces TRA, TRB are realized in such a way that they behave differently depending on the signal transmitted on the wire 11.

In particular, in case of transmission of a signal corresponding to a first logical level (e.g. a logical level LOW or logical 0), the interfaces TRA, TRB behave as high input impedances. In case of transmission of a signal corresponding to a second logical level (e.g. a logical level HIGH or logical 1), the interfaces TRA, TRB behave as voltage generators having low series impedances.

In a bidirectional and simultaneous communication system 10 according to an embodiment of the invention, which comprises devices provided with interfaces TRA, TRB of this type, the logical level of the wire 11 is the result of the operation of logical OR between the two signals transmitted by the devices A and B. In particular:
1. if the first device A transmits a logical 0 and the second device B transmits a logical 0, the logical level of the wire 11 is a logical 0 (e.g. equivalent to the ground voltage, that is 0 Volt);
2. if the first device A transmits a logical 0 and the second device B transmits a logical 1, the logical level of the wire 11 is a logical 1 (e.g. equivalent to the power supply voltage, that is 5 Volt);
3. if the first device A transmits a logical 1 and the second device B transmits a logical 0, the logical level of the wire 11 is a logical 1 (e.g. equivalent to the power supply voltage, that is 5 Volt);
4. if the first device A transmits a logical 1 and the second device B transmits a logical 1, the level of the wire 11 is still a logical 1 (e.g. equivalent to the power supply voltage, that is 5 Volt).

In the bidirectional and simultaneous communication system 10, it is possible to perform the transmission and the receiving of the signals contemporaneously on the same wire 11. In fact, supposing that the first device A is transmitting a signal to the second device B, at the same time this first device A can reconstruct the signal transmitted by the second device B since this first device A knows the signal that it is transmitting, the logical level of the wire 11, and the value of the current supplied by its interface TRA.

We will describe now the operation of the bidirectional and simultaneous communication system 10 in its different operating conditions.

When the first device A transmits a logical 0, the level of the wire 11 is the signal transmitted by the second device B, since it is the result of a logical OR operation between the signals transmitted by the first device A and the second device B. In this case, the first device A can reconstruct the signal transmitted by the second device B simply verifying the logical level of the wire 11.

On the contrary, when the first device A transmits a logical 1, it cannot reconstruct the signal transmitted by the second device B knowing only the logical level of the wire 11. In fact, this level is not influenced by the signal transmitted by the second device B anymore.

Advantageously according to an embodiment of the invention, to solve this indetermination, it is used a sensing of the current supplied by the interfaces TRA and TRB to the wire 11. With a detailed analysis of the configuration of the bidirectional and simultaneous communication system 10 shown in FIG. 4A for example, it can be verified that if the first device A transmits a logical 1 (e.g. equal to 5 Volt), the voltage on the wire 11 will be 5 Volt independently from the signal transmitted by the second device B. Although, the current supplied by the interface TRA of the first device A to the wire 11 will depend on the logical level transmitted by the interface TRB of the second device B. In fact, it can be applied the Kirchhoff's law to a cut K made in proximity of the input of the wire 11 into the interfaces TRA and TRB and in proximity of the wire 11 between the resistor R and the ground GND. This way, it can be verified that the value of the current supplied to the wire 11 by the interface TRA of the first device A is different when the second device B transmits a logical 1 (i.e. equal to 5 Volt) or a logical 0 (i.e. equal to high impedance) through the wire 11.

In particular, in the case that the second device B transmits a logical 0, the interface TRA of the first device A will supply a current equal to 5 Volt/R Ohm (if the logical level 1 corresponds to 5 Volt). Instead, when the second device B transmits a logical 1, the interface TRA of the first device A will supply a current equal to 5 Volt/2R Ohm, that is exactly half the one of the first case.

This way, using the logical level present on the wire 11 and the value of the current supplied to the wire 11 by its interface TRA, the first device A is able to reconstruct the signal transmitted by the second device B. This is still true when the first device A is transmitting a logical 1 contemporaneously to the signal transmitted by the device B.

It should be noted that the situation of indetermination described above (when the device A transmits a logical 1) could be solved if the logical level of the wire 11 were the result of a logical EX-OR operation (i.e. Exclusive-OR) between the signals transmitted by the devices A and B. This way for example, the recombination made by the first device A of the signal transmitted by the device A itself and the level of the wire 11 (which would be the result of the logical operation EX-OR between the two signals transmitted by the devices A and B) through a further EX-OR operation, would give as a result the signal transmitted by the device B.

In practice, a system of this kind is not achievable using only one wire since it is impossible to physically build a wire that takes a voltage level corresponding to a logical 0 when both its ends have a voltage level corresponding to a logical 1.

Advantageously according to an embodiment of the invention, the interfaces TRA and TRB of the described bidirectional and simultaneous communication system 10 allow to locally reconstruct a logical level inside every device A and B of the system itself. This logical level is function of the logical level transmitted and of the current supplied to the wire 11 by the interface itself. Similarly to the above described case, recombining the obtained logical level with the signal of the wire 11 (which is in this case the result of a logical OR operation between the logical levels transmitted by the interfaces of the two devices A and B) through a logical EX-OR operation, the logical level transmitted by the other device can be reconstructed.

In other words, it is proposed here a bidirectional and simultaneous communication system, made according to the communication-management method of the invention. The system comprises a first device A and a second device B, both provided with corresponding interfaces TRA, TRB and interconnected through a wire 11, which is in turn connected to a voltage reference, e.g. the ground GND, through a resistive element R. Advantageously according to the communication-management method of the invention, the bidirectional and simultaneous communication system provides a number of phases carried out by the corresponding device.

In particular, considering a device A, the system provides the following phases:
sensing the logical level of the wire 11;
sensing the current supplied to the wire 11 by the interface TRA of the device A;
reconstructing the logical level transmitted by another device B using the following rules:
a. if the device A transmits a logical 0, the logical level of the wire 11 corresponds to the signal transmitted by the other device B, since it is the result of a logical OR operation between the signal transmitted by the device A and by the device B;
b. if the device A transmits a logical 1 and its interface TRA supplies a current equal to V1/R (where V1 is the voltage corresponding to the logical level 1 and R is the value of the resistive element R connecting the wire 11 to the ground), the signal transmitted by the other device B is equal to a logical 0;
c. if the device A transmits a logical 1 and its interface TRA supplies a current equal to V1/2R, the signal transmitted by the other device B is equal to a logical 1.

This way, according to the management method for the exchange of digital signals of the invention, sensing the logical level of the wire 11 and also the current supplied by its interface TRA, a device A connected to said wire 11 can reconstruct the signal transmitted by another device B connected to the same wire 11. This happens while the device A itself is transmitting another digital signal to the device B. It can be seen that this is made performing the equivalent of a logical EX-OR operation between the signal transmitted and the logical level of the wire 11.

Even though the explanation has been made referring to the bidirectional and simultaneous communication system 10 shown in FIG. 4A, which comprises the connection between only two devices using the described bidirectional and simultaneous interface, the management method for the exchange of digital signals according to an embodiment of the invention can be applied to the communication of a plurality of devices connected to the wire 11 too. In fact, such a communication is managed by known protocols whose purpose is to rule the beginning and the end of the exchange of data. It always takes place between two and only two devices of the N (where N is a number greater than 2) devices connected to the bus.

It is possible to describe the management method for the exchange of digital signals in a general way considering the simplified scheme of FIG. 4B. In particular, according to the management method of the invention, digital signals are exchanged between a device X and a device Y both provided with corresponding interfaces TRX, TRY and interconnected through a wire C to implement the bidirectional and simultaneous communication system 10.

In particular, the method comprises the following phases:
sensing a logical level of the wire C;
sensing a current supplied to the wire C by the interface TRX of the device X;
reconstructing the logical level contemporaneously transmitted by the device Y, based upon said sensing phases and by means of a proper logical recombination of the level transmitted by the device X and the logical level present on the wire C as a function of the current supplied by the interface TRX of the device X to the wire C.

In FIG. 5 it is shown a bidirectional and simultaneous communication system 10 comprising a plurality of devices X1, . . . , Xn, in particular digital devices, connected to a wire 11. Every device Xn connected to the wire 11, which needs to simultaneously transmit and receive, is provided with an interface TRn according to an embodiment of the invention.

Though, it is possible to consider the case of a digital bidirectional communication system comprising also devices that does not need a bidirectional and simultaneous communication and that are hence not provided with such an interface but with a currently-used communication interface (e.g. I²C interface).

FIG. 6 shows with more detail an example of interface TR able to implement the management method for the exchange of digital signals according to an embodiment of the invention. In particular, the interface TR comprises a transmission section STX and a receiving section SRX connected to the wire 11 as well as to the corresponding transmission and receiving terminals, TX and RX.

Advantageously according to an embodiment of the invention, the transmission section STX has an input terminal corresponding to the transmission terminal, a first output terminal connected to the wire 11 and a second output terminal connected to a first input terminal of the receiving section SRX, which has also a second input terminal connected to the wire 11 and an output terminal corresponding to the receiving terminal RX.

In particular, the transmission section STX comprises a driver 12 having a first input terminal corresponding to said transmission terminal TX, where it is applied a signal DTx to transmit to the wire 11, as well as a first output terminal O1 able to drive the wire 11, as above described. The driver 12 also has a second output terminal O2 connected to a voltage comparator 13.

The voltage comparator 13 also has an output terminal O3 connected to an input terminal of the receiving section SRX.

The receiving section SRX comprises in particular a logical EX-OR gate 15, whose input terminals are connected to the output of the voltage comparator 13 as well as to the wire 11 through a delay element 14. The output of the logical gate 15 is output connected to the receiving terminal RX.

In particular, the voltage value V_{O2} at the second output terminal O2 of the driver 12 depends on two parameters: the signal DTx that the driver 12 itself is transmitting and the current supplied for the transmission of that signal. Supposing that it belongs to the interface TRA and considering a power-supply voltage Vcc for the driver 12 equal to 5 Volt, such voltage value V_{O2} at the output of the driver 12 can take three voltage levels:
a. when the driver 12 of a device A transmits a logical 0 (e.g. 0 Volt) through the wire 11, the value of the output voltage V_{O2} is close to 0 Volt and does not depend on the signal transmitted by the opposite device B, since the current supplied to the wire 11 by the driver 12 of the device A is zero in both cases;
b. when the driver 12 of the device A transmits a logical 1 (e.g. 5 Volt) through the wire 11 and the driver of the opposite device B transmits a logical 0, the current supplied by the driver 12 of the device A is maximum and equal to 5 Volt/R Ohm. Therefore the output voltage V_{O2} of the driver 12 has a value close to 5 Volt;
c. when the driver 12 of the device A transmits a logical 1 (which is a voltage value equal to the one of the previous case) through the wire 11 and the driver of the opposite device B transmits a logical 1 (which is also a voltage value equal to the one of the previous case) through the wire 11, the output voltage V_{O2} of the driver 12 has a value intermediate between 0 Volt and 5 Volt. In fact, even though the driver 12 of the device A applies a voltage value equal to 5 Volt to the wire 11, it will supply to the wire 11 a current equal to half the one of the previous case, i.e. a current equal to 5 Volt/2R Ohm.

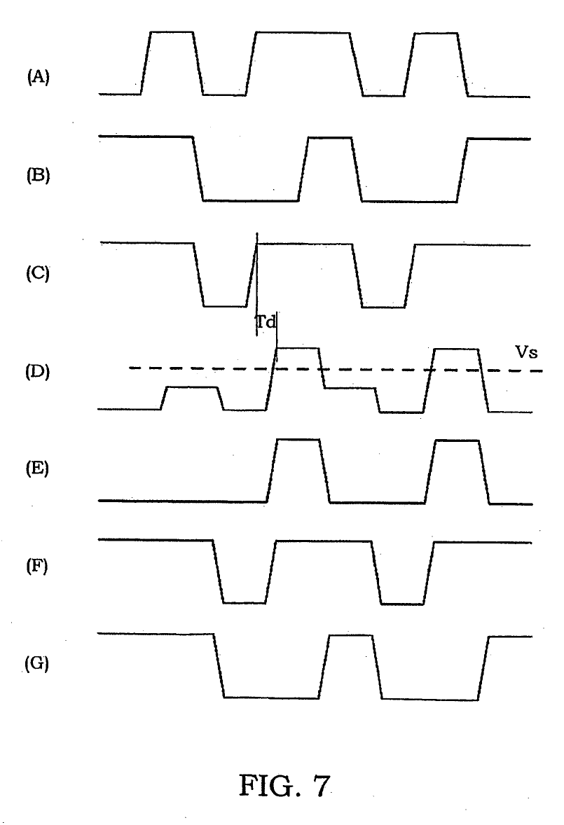

Advantageously according to an embodiment of the invention, using the voltage comparator 13 placed at the output of the driver 12, the interface TR reconstructs a purely digital signal starting from these levels of the output voltage V_{O2}. The threshold value for the voltage comparator is an intermediate voltage between the voltages reached in the above described cases b and c, as schematically shown in FIG. 7.

This way, at the output terminal O3 of the voltage comparator 13 a digital signal is provided, which can take only two voltage levels and reaches the level of a logical 1 only when the driver 12 of the device A transmits a logical 1 and the driver of the opposite device B transmits a logical 0 (case b previously described).

The signal obtained in this way is then combined through the logical EX-OR gate 15 with the signal taken from the wire 11, which is in its turn the result of a logical OR operation between the two signals transmitted by the devices A and B. This produces at the receiving terminal RX of the interface TRA of the device A exactly the logical level of the signal transmitted by the device B.

According to another embodiment of the interface according to an embodiment of the invention, no voltage comparator is used, in particular where the output voltage V_{O2} is sufficiently wide and the logical levels corresponding to the logical 0 and to the logical 1 are clearly distinguished without using any threshold-based comparison.

The FIG. 7 shows the graphs of the signals inside the bidirectional and simultaneous communication system 10 comprising a first device A and a second device B. In particular, with reference to FIG. 6, the FIG. 7 shows:

(A) the logical level, i.e. the voltage value, applied to the wire 11 by the first device A and corresponding to the signal to be transmitted by the device A;
(B) the logical level, i.e. the voltage value, applied to the wire 11 by the second device B and corresponding to the signal to be transmitted by the device B;
(C) the voltage value of the wire 11, resulting from the logical OR operation between the two logical levels provided by the devices A and B;
(D) the value of the output voltage V_{O2} of the driver 12 of the first device A, also showing the value Vs used as a threshold value for the voltage comparator 13 of such device A, as well as the delay value Td introduced by the driver 12 itself;
(E) the value of the output voltage V_{O3} of the voltage comparator 13 of the first device A;
(F) the value of the output voltage of the delay element 14, corresponding to the value of the voltage of the wire 11 delayed of a value Td;
(G) the signal RX at the output terminal O4 of the interface TRA of the first device A, corresponding to the reconstruction of the signal transmitted by the second device B (i.e. graph B plus a delay Td).

It should be noted that the description of the communication system according to an embodiment of the invention comprising the devices A and B has been made analyzing the behavior of the interface from the side of the device A with the only purpose to simplify the description. In fact, the same considerations can be done analyzing the system from the opposite side that is the side of the device B.

FIG. 8 shows with more detail a circuital configuration able to implement the driver 12 and the voltage comparator 13 of the transmission section STX of the example interface TR according to an embodiment of the invention.

In particular, the driver 12 comprises an operational amplifier IC1 inserted between a first voltage reference Vcc and a second voltage reference GND, e.g. a power supply voltage and a ground.

The operational amplifier IC1 has a non-inverting input terminal N1 (+) connected to the transmission terminal TX through a first resistor R1 and a first diode D1, which have an intermediate node N2 connected to the voltage reference GND through a second resistor R2.

The operational amplifier IC1 further has an inverting input terminal N3 (−) connected to the transmission terminal TX through a third resistor R3, as well as an output terminal N4 feedback-connected to the inverting input terminal N3 (−) through a fourth resistor R4 and to the ground GND through a fifth resistor R5.

The inverting input terminal N3 (−) of the operational amplifier IC1 is then connected to the output terminal O1 of the driver 12 through a second diode D2. The output terminal O1 is in its turn connected to the wire 11.

In FIG. 8 it is also shown the configuration of the voltage comparator 13, included into the transmission section STX of the example interface TR according to an embodiment of the invention.

In particular, the voltage comparator 13 comprises a comparator IC2 inserted between the power supply voltage reference Vcc and the ground GND, which has a positive input terminal N5 (+) connected to the output terminal N4 of the operational amplifier IC1 of the driver 12.

The comparator IC2 has a negative input terminal N6 (−) connected to an intermediate node of a resistive divider including a sixth resistor R6 and a seventh resistor R7, which are inserted, in series to one another, between the power supply voltage reference Vcc and the ground GND. It is also included a capacitor C1 inserted, in parallel to the sixth resistor R6, between the negative input terminal N6 (−) of the comparator IC2 and the ground GND.

Finally, the comparator IC2 has an output terminal N7 connected to the output terminal O3 of the transmission section STX as well as to the ground GND through an eighth resistor R8.

This way, the comparator IC2 will have its threshold value set by the resistive divider of the sixth resistor R6 and the seventh resistor R7.

As already described, such a threshold value of the comparator 13 should be in a range between a maximum voltage value and an intermediate voltage value of the output voltage of the driver 12. In particular, these voltage values are reached correspondingly when only the interface comprising said comparator transmits a logical value 1 and when both interfaces transmit a logical value 1, as shown in FIG. 7 by the hatched line (graph D).

FIG. 9 shows the receiving section SRX of the interface TR realized according to an embodiment of the invention.

The receiving section SRX comprises in particular the series of the delay element 14 and of the logical gate 15 inserted between the wire 11 and a receiving terminal RX.

The logical gate 15 is inserted between the power supply voltage reference Vcc and the ground GND. It has a first input terminal connected to the output terminal O3 of the voltage comparator 13, a second input terminal connected to the delay element 14 and an output terminal connected to the receiving terminal RX.

Advantageously according to an embodiment of the invention, the delay element 14 comprises a receiving buffer 16 connected in series to a delay block 17. The receiving buffer 16 has a high impedance and it is able to sense the voltage signal of the wire 11 without loading the wire 11 and to forward the voltage signal to the delay block 17.

The delay block 17 introduces a delay equal to Td to the signal present on the wire 11, compensating in this way the delay introduced by the operational amplifier IC1 of the driver 12 (as shown in FIG. 7).

The logical EX-OR gate 15 recombines then in the right way the signal of the output terminal O3 of the voltage comparator 13 and the signal of the wire 11, thus obtaining the signal transmitted by the other side of the wire 11, while the interface itself is transmitting a signal to the other side of the wire 11.

It should be noted that the delays introduced by the receiving buffer 16 and by the voltage comparator 13 have not been considered, since they are usually small compared to the delay introduced by the driver 12 and they also tend to compensate one another.

The delay block 17 of the receiving section SRX is then sized in such a way to compensate the delay introduced by the driver 12 of the transmission section STX and taking into account the characteristics of the operational amplifier IC1.

Referring to FIG. 8, it is now explained a possible circuit to implement the interface TR according to an embodiment of the invention. With the only purpose to explain the working principle of the interface TR, the power supply voltage of the interface is assumed being a single ended 5 Volt.

Advantageously according to an embodiment of the invention, the TX terminal of the driver 12 should be driven by a voltage level corresponding to the logical level (i.e. logical 0 or 1) that it should transmit (i.e. 0 Volt or 5 Volt) to the other interface, and it should supply a current to the wire 11 greater than the maximum current required to set the wire 11 at a high voltage level (i.e. Vcc/R).

The operational amplifier IC1 of the driver 12 behaves like an amplifier due to the negative feedback of the resistor R4. This way the negative input terminal N3 follows the voltage level of the positive input terminal N1.

Below are described the two working phases of the driver 12 needed to transmit the 0 and 1 logical levels through the wire 11.
a) When the driver 12 transmits a logical 0, the voltage level at the TX terminal is 0 Volt thus the diode D1 is off and the input terminal N1 of the operational amplifier IC1 has two resistors R1, R2 in series connected to GND. Considering a small polarization current flowing through R1 and R2, the positive input terminal N1 has a positive voltage level slightly above 0 Volt. The negative input terminal N3 of the operational amplifier IC1, which follows the positive input terminal N1, cannot turn the diode D2 on. Hence, no current flows through D2 and the voltage of the wire 11 (loaded by the resistor R) remains close to 0 Volt.

The voltage level of the output terminal of the operational amplifier IC1 can be obtained with the following formula:
V_{N4}=[(V_{N3}×R4)R3]+V_{N3} (1)
Wherein:
V_{N4} is the voltage value of the output terminal N4 of the operational amplifier IC1;
R3, R4 are the values of the third and fourth resistors, respectively; and
V_{N3} is the voltage value of the negative input terminal N3 of the operational amplifier IC1.

The formula (1) takes into account, in the N3 node, only the current flowing through the R3 and R4 resistors because neither the diode D2 (which is switched off) nor the negative input terminal N3 (having a high impedance) of the operational amplifier IC1 have a current absorption.

It should be noted, that the voltage V_{N1} of the positive input terminal N1 depends on the small polarization current of the operational amplifier IC1, according to the following formula:
V_{N1}=Ipol×(R2+R1) Volt (2)
Wherein:
Ipol is the polarization current of the positive input terminal N1; and
R1, R2 are the values of the first and second resistors, respectively.

Being V_{N3}=V−=V+=V_{N1} and neglecting the offset voltage of the operational amplifier IC1), the voltage value of the output terminal N4 of the operational amplifier IC1 is therefore function of the voltage value V_{N1} and hence of the resistor value R2+R1 (see formula (2)).

In this case the R4/R3 ratio should be as small as possible in order to keep the voltage of the output terminal of IC1 (i.e. the output V_{O2} of the driver 12) close to 0 Volt.
b) When the driver 12 transmits a logical 1 to the wire 11, the voltage level of the TX terminal is 5 Volt. In this case a forward current flows through the first diode D1 and the voltage value of the positive input terminal N1 of the operational amplifier IC1 is:
   V_{N1}=5−V_{D1} Volt (neglecting the drop across resistor R1) (3)
Wherein:
V_{N1} is the voltage value of the input positive terminal N1 of IC1; and
V_{D1} is the voltage drop across the first diode D1.

Thanks to the negative feedback, the negative input terminal N3 of IC1 follows the positive input terminal N1. Thus, assuming that the drop on the diode is 0.2 Volt, the voltage value V_{N3} would be:
V_{N3}=V_{N1}=4.8 Volt (neglecting the offset voltage of the operational amplifier IC1).

This voltage value is enough to switch the second diode D2 on. Thus the voltage value of the wire 11 is 4.8 Volt minus the voltage drop across the second diode D2. Considering for example a voltage drop of 0.2 Volt across the second diode D2, the voltage value of the wire 11 would be 4.6 Volt that represents the transmission of a logical HIGH level i.e. a logical 1.

As described above, in this condition the outgoing current of the interface needed to set the wire 11 at a high voltage level can be:
1) 4.6 Volt/R Ohm if the opposite interface transmits a logical 0;
2) 4.6 Volt/2R Ohm if the opposite interface transmits a logical 1.

Advantageously according to an embodiment of the invention the value of the third resistor R3 is calculated in order to have a current flowing through it equal to the maximum outgoing current (i.e. 4.6 Volt/R Ohm):
R3=(V_{D1}×R)/4.6 Volt (4)
Wherein:
V_{D1} is the voltage drop across the first diode D1;
V_{R3} is the voltage drop across the third resistor R3;
R is the value of the pull-down resistor of the wire 11;
and assuming

V_{D1}=V_{R3} (neglecting the drop across the resistor R1 and the offset voltage of the operational amplifier IC1).

This way the current flowing into the node N3 is distributed as it follows:
1) when the outgoing current of the interface is maximum, the current generated in the branch comprising the third resistor R3 flows entirely into the branch comprising the second diode D2 (i.e. through the first output of the driver 12 connected to the wire 11). Therefore, no current flows through the branch comprising the resistor R4 and there isn't any voltage drop across R4. The output voltage of the operational amplifier IC1 is:
   V_{N4}=V_{N3}=4.8 Volt (5)
Wherein
V_{N4} is the output voltage of the operational amplifier IC1;
V_{N3} is the voltage of the node N3 (i.e. of the negative input terminal N3 of the operational amplifier IC1);
2) when the outgoing current of the interface is minimum, half of the current generated in the branch comprising the third resistor R3 flows into the branch comprising the second diode D2, and the remaining half flows through the feedback fourth resistor R4 thus a voltage drop is generated across the fourth resistor R4. The output voltage of the operational amplifier IC1 is:
   V_{N4}=V_{N3}−(R4×I_{R4}) (6)
wherein:
R4 is the value of the fourth resistor R4;
I4 is the current flowing through the fourth resistor R4 (in this case=4.6 Volt/2R Ohm).

The value of the fourth resistor R4 will be chosen in order to obtain at the output of the operational amplifier IC1 a voltage level (i.e. V_{N4}) different from the one of the previously-described case 1.

It should be noted that all calculations done so far to determine the external components of the operational amplifier IC1 used in the driver 12 of the present invention assume that the operational amplifier IC1 behaves like a true linear amplifier. Despite this assumption, we can consider the calculations effective enough.

For a real analysis of the driver 12, it should be dealt with the analysis of the non-ideal behavior of the chosen operational amplifier. The choice of the operational amplifier to be used should take into account:
the speed of the communication to be obtained. The bandwidth and slew rate of the operational amplifier can affect the speed of the communication;
the common-mode input range, which should be wide enough to allow the operational amplifier to drive the connecting wire 11 to the required voltage level (i.e. logical HIGH and logical LOW) with a linear and stable behavior;
that a rail-to-rail input capability is needed if the required transmission voltage is close to the power-supply voltage;
that since the trend in the digital field is to use devices with a low supply voltage (e.g. 3 Volt, 5 Volt), the operational amplifier should work with a low and single supply voltage.
that the input offset voltage of the operational amplifier should be as low as possible in order to have small differences between the voltage values of the two input terminals of the operational amplifier IC1.

Advantageously according to an embodiment of the invention, the output terminal N4 of the operational amplifier IC1 (i.e. the second output terminal V_{O2} of the driver 12 of FIG. 6) is connected to the positive input terminal N5 of the comparator IC2 (i.e. the comparator block 13 of FIG. 6). The threshold of the comparator IC2 is fixed by the resistive divider R6 and R7.

As previously said, the threshold voltage value should be an intermediate value between the maximum and the intermediate voltage value V_{O2} reached at the output terminal O2 of the driver 12.

This way the voltage level of the output terminal N7 of the comparator IC2 would be 5 Volt if the voltage of the positive input terminal N5 is greater than the fixed threshold voltage value. On the contrary, it would be 0 Volt if the voltage of the positive input terminal N5 is lower than the fixed threshold voltage value.

The receiving section SRX has a receiving buffer 16, which senses the status of the wire 11 without loading the wire 11 thanks to its high impedance. After checking the logical state of the wire 11, the signal goes through a delay block 17 in order to compensate the delay introduced by the driver 12. At this point, the logical level V_{O3} (i.e. the digital signal) at the output terminal O3 of the comparator 13 (graphic E in FIG. 7) can be combined with the one at the output terminal of the delay block 17 (i.e. the logical level of the wire 11 plus a delay Td as shown in the graph F of FIG. 7) through an EX-OR gate 15. This way, it can be obtained at the output terminal of the EX-OR gate RX (graph G of FIG. 7) the digital signal transmitted simultaneously by the opposite interface.

The transmission and receiving scheme just described referring to the bidirectional and simultaneous digital communication system 10 can also work with more than two devices sharing the same bus, as shown in FIG. 5.

In particular, in a system like the one in FIG. 5 the simultaneous modality can be used only after an addressing phase. In fact, in order to put in communication two of the connected devices, a master device starts a transmission session with the address byte of the device it wants to communicate to. The voltage level of the wire 11 in the addressing phase, to be read by all connected devices, cannot be a logical combination (e.g. AND or OR) between two digital signals but it should be the digital signal representing the address byte itself.

Even though all the discussion done so far refers to an interface with a pull-down resistor that pulls the wire 11 towards the low voltage level (e.g. 0 Volt), a system with a pull-up resistor is achievable taking into account that:
a) loading the wire 11 with a pull-up resistor, the logical level of the wire 11 will be the result of a logical AND between the transmitted signals of the two communicating devices;
b) the driver 12 should release the wire (high impedance) when it should transmit a logical 1, hence the cathode and anode of the second diode D2 should be inverted;
c) the indetermination previously described takes place now when the interface is transmitting a logical 0 instead of a logical 1;
d) the driver 12 should sense the current supplied to the wire 11 only when it is transmitting a logical 0, the first diode D1 has the anode and the cathode inverted (compared to FIG. 8) and it is connected to the power supply Vcc through the resistor R1. It should be taken into account that the currents in the node N3 and thus in the related branches, are now inverted;
e) the threshold voltage value Vs of the voltage comparator 13 should be in a range between a minimum and an intermediate value of the voltage of the output terminal N4 of the driver 12;
f) an EX-NOR gate instead of the EX-OR gate 15 is required to reconstruct the received signal.

The main advantages of the bidirectional and simultaneous digital management method, of the transmission interface TR and of the communication system 10 can be resumed into the following ones:
1) a digital bidirectional and simultaneous communication by means of only one wire (plus a common voltage reference e.g. GND) is obtained without modulating or modifying the base-band digital signal, which means transmitting only a pure digital signal;
2) despite a full-duplex capability (i.e. exchanging a double amount of digital data compared to conventional one-wire half-duplex communications), a double bandwidth is not needed to communicate in full-duplex modality;
3) the transmission modality can be either synchronous or asynchronous;
4) the two transmitted signals can have no bonds or dependencies of frequency and/or phase;
5) there isn't any possibility of conflict of the bidirectional digital signals on the wire during the data-exchange between two communicating devices;
6) thanks to the previous advantage, the system does not require using particularly complicated protocols but the protocols themselves can be less restrictive than the currently-known protocols for bus systems;
7) during the data-exchange, two interfaces (both made according to the specifics of the invention) can freely start, pause and stop the simultaneous modality of the transmission;
8) if two of the interfaces according to an embodiment of the invention communicate using only the half-duplex modality and if the receiving interface holds the wire to the forced level (e.g. the logical level 1 if using a wire implementing a logical OR), the transmitting interface can communicate without changing the voltage level of the wire. This way, the parasitic capacitors of the wire cannot affect the communication;
9) an interface made according to an embodiment of the invention can communicate also with any standard interface (e.g. the I²C interface) simply avoiding the full-duplex modality;
10) it is possible to implement also a parallel communication with K bits (wherein K is a number greater than 1) simply placing side by side K single wires like the one described above.

In conclusion, the present invention provides a hardware communication method that combines the advantages of the USART-like interfaces (i.e. full-duplex capability) and of the I²C-like interfaces, making it possible to build a full-duplex bus system by means of only one single wire.

The described invention does not relate to a new protocol for a network communication but to a new hardware method to obtain a true digital base-band communication by means of only one single wire. It has a full-duplex capability and besides being able to work with the currently-known protocols, it can work even with less restrictive ones.

Changes can be made to the invention in light of the above detailed description. In general, in the following claims, the terms used should not be construed to limit the invention to the specific embodiments disclosed in the specification and the claims, but should be construed to include all methods and devices that are in accordance with the claims. Accordingly, the invention is not limited by the disclosure, but instead its scope is to be determined by the following claims.

1) A management method for a bidirectional and simultaneous exchange of digital signals between at least a first device and a second device, both provided with a corresponding interface and interconnected by means of at least one connecting wire where there is a pure digital signal that can take only two voltage levels, the method comprising the following phases:
sensing a voltage level of the connecting wire;
sensing a current supplied to the connecting wire by the interface of the first device, without changing the voltage level of the connecting wire;
local reconstruction of a logical level transmitted by the interface of the second device by means of a logical recombination of the voltage level sensed on the connecting wire and the logical level transmitted by the interface of the first device, depending on the current supplied by the interface of the first device to the connecting wire.

2) The management method according to claim 1, wherein the two voltage levels correspond to a first logical level and a second logical level in their turn corresponding to the result of a logical OR or AND operation between the signals transmitted by the first and second devices.

3) The management method according to claim 2, wherein the logical recombination is achieved by means of a logical EX-OR or EX-NOR operation depending on the logical level of the connecting wire according to the following rules:
if the logical level of the connecting wire corresponds to an OR operation, the logical recombination is achieved by means of an EX-OR operation;
else if the logical level of the connecting wire corresponds to an AND operation, the logical recombination is achieved by means of an EX-NOR operation.

4) The management method according to claim 3, wherein the EX-OR or EX-NOR operations are performed between the logical level sensed on the connecting wire and a logical level obtained from the logical level transmitted by the interface of the first device and the sensed current supplied by the interface of the first device to the connecting wire.

5) The management method according to claim 1, wherein the operation of the first and second devices and corresponding interfaces is cross-changed.

6) An interface for a bidirectional and simultaneous transmission of digital signals, comprising: a transmission section connected to a transmission terminal and to a receiving section, in turn connected to a receiving terminal, wherein the transmission section has a first output terminal connected to a connecting wire and a second output terminal, in its turn connected to a first input terminal of the receiving section, which has in turn a second input terminal connected to the connecting wire and the transmission section comprises a driver which performs both the transmission and the current detection functions combined into one device.

7) The interface according to claim 6, wherein the driver has a first input terminal corresponding to the transmission terminal, a first output terminal connected to the connecting wire and a second output terminal connected to a voltage comparator, the output voltage level of the second output terminal depending on a logical level transmitted by the driver and on a sensed current level supplied to the connecting wire.

8) The interface according to claim 7, wherein the driver comprises at least one operational amplifier inserted between a first voltage reference and a second voltage reference and having an inverting input terminal and a non-inverting input terminal connected to the transmission terminal through a plurality of passive components, as well as an output terminal, corresponding to the second output terminal, connected with a feedback resistive element to the inverting input terminal.

9) The interface according to claim 8, wherein the inverting input terminal of the operational amplifier is also connected to the connecting wire through a diode.

10) The interface according to claim 8 wherein the non-inverting input terminal of the operational amplifier is connected to the transmission terminal through a first resistive element and a diode having an intermediate node connected to the second voltage reference through a second resistive element.

11) The interface according to claim 8 wherein the inverting input terminal of the operational amplifier is connected to the transmission terminal through a third resistive element.

12) The interface according to claim 8, wherein the output terminal of the operational amplifier is connected to the second voltage reference through a fifth resistive element.

13) The interface according to claim 7, wherein the voltage comparator comprises a comparator which is inserted between the first voltage reference and the second voltage reference and having a positive input terminal connected to the second output terminal of the driver.

14) The interface according to claim 13, wherein the comparator has a negative input terminal connected to an intermediate node of a resistive divider inserted between the first voltage reference and the second voltage reference and able to set a threshold value of the comparator.

15) The interface according to claim 14, wherein the threshold value is a voltage value in a range between a maximum value and an intermediate value or in a range between a minimum value and another intermediate value of the output voltage level of the output terminal of the driver, in case that the connecting wire implements respectively an OR or an AND logical operation.

16) The interface according to claim 14, wherein the resistive divider comprises a first resistive element and a second resistive element, both inserted, in series to each other, between the first voltage reference and the second voltage reference, and in that the comparator further comprises a capacitor inserted, in parallel to the first resistive element, between the negative input terminal of the comparator and the second voltage reference.

17) The interface according to claim 13, wherein the comparator has an output terminal, which corresponds to an output terminal of the voltage comparator, and is connected to the second voltage reference through a further resistive element.

18) The interface according to claim 13, wherein the receiving section comprises a logical EX-OR or EX-NOR gate, in case that the connecting wire implements respectively an OR or an AND logical operation, the logical gate being inserted between the first voltage reference and the second voltage reference and having two input terminals, one connected to the output terminal of the voltage comparator and the other connected to the connecting wire through a delay device, as well as having an output terminal corresponding to the receiving terminal of the receiving section.

19) The interface according to claim 18, wherein the delay device comprises a receiving buffer having high input impedance and being connected in series to a delay circuit, the receiving buffer being able, due to its high input impedance, to sense a voltage level of the connecting wire without loading the connecting wire and to forward the voltage level to the delay circuit.

20) The interface according to claim 19, wherein the delay circuit adds a delay to the sensed voltage level of the connecting wire in order to compensate a delay introduced by the driver.

21) A system for a bidirectional and simultaneous communication comprising at least a device and another device provided with corresponding interfaces interconnected by means of at least one connecting wire, wherein the interfaces include: a transmission section connected to a transmission terminal and to a receiving section, in turn connected to a receiving terminal, wherein the transmission section has a first output terminal connected to a connecting wire and a second output terminal, in its turn connected to a first input terminal of the receiving section, which has in turn a second input terminal connected to the connecting wire and the transmission section comprises a driver which performs both the transmission and the current detection functions combined into one device.

22) The system according to claim 21, wherein the driver has a first input terminal corresponding to the transmission terminal, a first output terminal connected to the connecting wire and a second output terminal connected to a voltage comparator, the output voltage level of the second output terminal depending on a logical level transmitted by the driver and on a sensed current level supplied to the connecting wire.

23) The system according to claim 21, wherein the driver comprises at least one operational amplifier inserted between a first voltage reference and a second voltage reference and having an inverting input terminal and a non-inverting input terminal connected to the transmission terminal through a plurality of passive components, as well as an output terminal, corresponding to the second output terminal, connected with a feedback resistive element to the inverting input terminal.

24) The system according to claim 23, wherein the inverting input terminal of the operational amplifier is also connected to the connecting wire through a diode.

25) The system according to claim 23 wherein the non-inverting input terminal of the operational amplifier is connected to the transmission terminal through a first resistive element and a diode having an intermediate node connected to the second voltage reference through a second resistive element.

26) The system according to claim 23 wherein the inverting input terminal of the operational amplifier is connected to the transmission terminal through a third resistive element.

27) The system according to claim 23, wherein the output terminal of the operational amplifier is connected to the second voltage reference through a fifth resistive element.

28) The system according to claim 22, wherein the voltage comparator comprises a comparator which is inserted between the first voltage reference and the second voltage reference and having a positive input terminal connected to the second output terminal of the driver.

29) The system according to claim 28, wherein the comparator has a negative input terminal connected to an intermediate node of a resistive divider inserted between the first voltage reference and the second voltage reference and able to set a threshold value of the comparator.

30) The system according to claim 29, wherein the threshold value is a voltage value in a range between a maximum value and an intermediate value or in a range between a minimum value and another intermediate value of the output voltage level of the output terminal of the driver, in case that the connecting wire implements respectively an OR or an AND logical operation.

31) The system according to claim 29, wherein the resistive divider comprises a first resistive element and a second resistive element, both inserted, in series to each other, between the first voltage reference and the second voltage reference, and in that the comparator further comprises a capacitor inserted, in parallel to the first resistive element, between the negative input terminal of the comparator and the second voltage reference.

32) The system according to claim 28, wherein the comparator has an output terminal, which corresponds to an output terminal of the voltage comparator, and is connected to the second voltage reference through a further resistive element.

33) The system according to claim 28, wherein the receiving section comprises a logical EX-OR or EX-NOR gate, in case that the connecting wire implements respectively an OR or an AND logical operation, the logical gate being inserted between the first voltage reference and the second voltage reference and having two input terminals, one connected to the output terminal of the voltage comparator and the other connected to the connecting wire through a delay device, as well as having an output terminal corresponding to the receiving terminal of the receiving section.

34) The system according to claim 33, wherein the delay device comprises a receiving buffer having high input impedance and being connected in series to a delay circuit, the receiving buffer being able, due to its high input impedance, to sense a voltage level of the connecting wire without loading the connecting wire and to forward the voltage level to the delay circuit.

35) The system according to claim 34, wherein the delay circuit adds a delay to the sensed voltage level of the connecting wire in order to compensate a delay introduced by the driver.

36) The system according to claim 21, wherein the interfaces behave in a different manner depending on a logical level transmitted through the connecting wire, thus implementing a logical OR or AND operation on the connecting wire between a logical level transmitted by an interface and a logical level transmitted by another interface, the interfaces behaving as high input impedances in case of transmission of a first logical level and as voltage generators having low series impedances in case of transmission of a second logical level.

37) The system according to claim 36, wherein it executes the following rules:
a. if the device is transmitting the first logical level, the logical level of the connecting wire corresponds to the logical level transmitted by the another device;
b. if the device is transmitting the second logical level and the interface of the device is supplying a first current level to the connecting wire, the logical level transmitted by the another device corresponds to the first logical level;
c. if the device is transmitting the second logical level and the interface of the device is supplying a second current level to the connecting wire, the logical level transmitted by the another device corresponds to the second logical level.

38) The system according to claim 21, wherein it comprises a plurality of devices, interconnected by means of the at least one connecting wire and provided with corresponding interfaces and using a proper communication protocol to rule the beginning, the progress, the stand-by and the end of the communication, in such a way that the connection is always achieved at a given time between only two of the n devices which are connected to the connecting wire.

39) The system according to claim 21, wherein it comprises a plurality of devices connected in parallel to a plurality of wires to achieve a parallel transmission of a plurality of parallel bits.
